(19) United States
(12) Patent Application Publication
(10) Pub. No.: US 2015/0304898 A1
(43) Pub. Date: Oct. 22, 2015

(54) SYSTEMS, METHODS AND APPARATUS FOR CONTROLLING OFFLOADABILITY OF PUBLIC DATA NETWORK CONNECTIONS TO WIRELESS LOCAL AREA NETWORKS AND DETACH FROM CELLULAR NETWORKS

(71) Applicant: QUALCOMM Incorporated, San Diego, CA (US)

(72) Inventor: Stefano Faccin, Hayward, CA (US)

(21) Appl. No.: 14/686,580

(22) Filed: Apr. 14, 2015

Related U.S. Application Data
(60) Provisional application No. 61/982,280, filed on Apr. 21, 2014.

(51) Int. Cl. H04W 36/00; H04W 28/08; H04W 28/02

(52) U.S. Cl. CPC H04W 36/0022; H04W 28/0289; H04W 28/08

(57) ABSTRACT

Systems, methods, and apparatuses for controlling offloadability of public data network (PDN) connections to wireless local area networks (WLANs) and detach from cellular wireless networks are described herein. An apparatus for wireless communication comprises a receiver configured to receive a first indication from a cellular wireless network that the apparatus may selectively offload all data connections except one between the apparatus and the cellular wireless network to the non-cellular wireless network. The apparatus further comprises a processor configured to selectively offload at least a subset of the data connections to the non-cellular wireless network based on the first indication. The receiver may further be configured to receive a second indication indicating that all data connections between the apparatus and the cellular wireless network may be offloaded to the non-cellular wireless network.

### CROSS REFERENCE TO RELATED APPLICATIONS

This application claims priority to Provisional Application No. 61/982,280 entitled “SYSTEMS, METHODS AND APPARATUS FOR CONTROLLING OFFLOADABILITY OF PUBLIC DATA NETWORK CONNECTIONS TO WIRELESS LOCAL AREA NETWORKS AND DETACH FROM CELLULAR NETWORKS” filed Apr. 21, 2014. The disclosure of Provisional Application No. 61/982,280 is hereby expressly incorporated in its entirety by reference herein.

### FIELD

The present application relates generally to wireless communications, and more specifically to systems, methods, and apparatus for controlling offloadability of public data network (PDN) connections to wireless local area networks (WLANs) and detach from cellular wireless networks.

### BACKGROUND

In order to manage congestion and improve user experience on cellular wireless communication networks, solutions have been devised that allow the offloading of certain cellular communications to locally available non-cellular communication channels. However, due to varying requirements of different types of cellular wireless networks, under certain situations, at least one data connection (e.g., a public data network (PDN) connection) may be required to remain connected to the cellular wireless network in order to maintain attachment to the cellular wireless network. Since data (e.g., PDN) connections are routinely removed and/or added between a particular user equipment (UE) and the cellular wireless network, it may be desirable to have the capability of dynamically updating an offloadability status of one or all currently active data (e.g., PDN) connections with the cellular wireless network. Accordingly, a need may exist for systems, methods, and apparatus for controlling offloadability of data (e.g., PDN) connections to wireless local area networks (WLANs) and detach from cellular wireless networks.

### SUMMARY

Various implementations of systems, methods and devices within the scope of the appended claims each have several aspects, no single one of which is solely responsible for the desirable attributes described herein. Without limiting the scope of the appended claims, some prominent features are described herein. Other features, aspects, and advantages will become apparent from the description, the drawings, and the claims.

In one implementation, an apparatus for wireless communication is provided. The apparatus includes a receiver configured to receive a first indication from a cellular wireless network that the apparatus may selectively offload all data connections except one between the apparatus and the cellular wireless network to the non-cellular wireless network. The apparatus further comprises a processor configured to selectively offload at least a subset of the data connections to the non-cellular wireless network based on the first indication.

In another implementation, a method for wireless communication is provided. The method comprises receiving a first indication from a cellular wireless network that the apparatus may selectively offload all data connections except one between the apparatus and the cellular wireless network to the non-cellular wireless network. The method further comprises a processor configured to selectively offload at least a subset of the data connections to the non-cellular wireless network based on the first indication.

In yet another implementation, an apparatus for wireless communication is provided. The apparatus includes means for receiving a first indication from a cellular wireless network that the apparatus may selectively offload all data connections except one between the apparatus and the cellular wireless network to the non-cellular wireless network. The apparatus further comprises means for selectively offloading at least a subset of the data connections to the non-cellular wireless network based on the first indication.

In yet another implementation, a non-transitory computer-readable medium is presented. The non-transitory computer-readable medium comprises code that, when executed, causes an apparatus to receive a first indication from a cellular wireless network that the apparatus may selectively offload all data connections except one between the apparatus and the cellular wireless network to the non-cellular wireless network. The code, when executed, further causes the apparatus to selectively offload at least a subset of the data connections to the non-cellular wireless network based on the first indication.

### BRIEF DESCRIPTION OF THE DRAWINGS

FIG. 1 illustrates an example of a wireless communication network in which aspects of the present disclosure may be employed.

FIG. 2 illustrates an example of a functional block diagram of a wireless device that may be employed within the wireless communication network of FIG. 1.

FIG. 3 illustrates an example of a functional block diagram of certain communication entities that may be employed within the wireless communication network of FIG. 1.

FIG. 4 illustrates a signal exchange diagram for indicating offloadability of one or more data connections to non-cellular wireless networks as may be employed within the wireless communication network of FIG. 1.

FIG. 5 shows a flowchart of an example method for wireless communication that may be employed within the wireless communication network of FIG. 1.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The following description is presented to enable any person skilled in the art to make and use the invention. Details are set forth in the following description for purpose of explanation. It should be appreciated that one of ordinary skill in the art would realize that the invention may be practiced without the use of these specific details. In other instances, well known structures and processes are not elaborated in order not to obscure the description of the invention with unnecessary details. Thus, the present invention is not intended to be limited by the implementations shown, but is to be accorded with the widest scope consistent with the principles and features disclosed herein.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, and/or Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of the Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2).

It should be emphasized that the disclosed techniques may also be applicable to technologies and the associated standards related to LTE, LTE Advanced, W-CDMA, TDMA, OFDMA, High Rate Packet Data (HRPD), Evolved High Rate Packet Data (eHRPD), Worldwide Interoperability for Microwave Access (WiMax), GSM, enhanced data rate for GSM evolution (EDGE), and so forth.

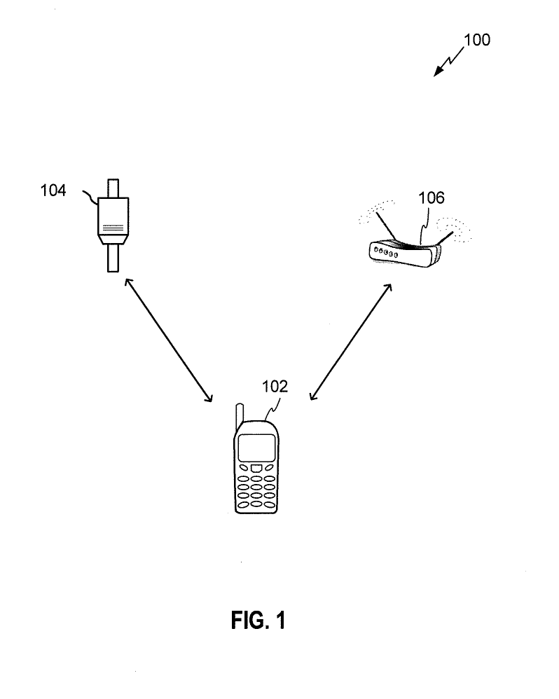

FIG. 1 illustrates an example of a wireless communication network or system 100 in which aspects of the present disclosure may be employed. The wireless communication system 100 may include a user equipment (UE) 102, which may be in wireless communication with one or both of a cellular wireless network (e.g., a 2G, 3G, and/or 4G LTE network) through a first access point (AP) 104 and with a non-cellular, wireless local area network (WLAN) through a second AP 106.

An access point (AP) (e.g., either of APs 104 and 106) may comprise, be implemented as, or known as a Node B, Radio Network Controller (RNC), eNodeB, Base Station Controller (BSC), Base Transceiver Station (BTS), Base Station (BS), Transceiver Function (TF), Radio Router, Radio Transceiver, Wi-Fi AP, or some other terminology.

The UE 102 may comprise, be implemented as, or known as an access terminal (AT), a subscriber station, a subscriber unit, a mobile station, a remote station, a remote terminal, a user terminal, a user agent, a user device, wireless station (STA), or some other terminology. In some implementations the UE 102 may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects disclosed herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a wireless sensor device, a global positioning system device, or any other suitable device that is configured to communicate via a wireless medium.

As shown in FIG. 1, multiple APs (e.g., the APs 104 and 106) may provide different communication paths for the UE 102. For example, the UE 102 may receive cellular service (e.g., 2G, 3G, and/or 4G LTE service) through the AP 104 and WLAN service through AP 106. As will be described in more detail below, the UE 102 may communicate over a cellular wireless network through the AP 104 utilizing one or more data (e.g., PDN) connections. Under certain conditions, it may be desirable for the UE 102 to offload one or more data connections from the cellular wireless network (via the AP 104) to the WLAN (via the AP 106). Performed efficiently, such offloading may improve user experience while simultaneously relieving cellular wireless network congestion by transferring the wireless traffic to and from the UE 102 through the WLAN.

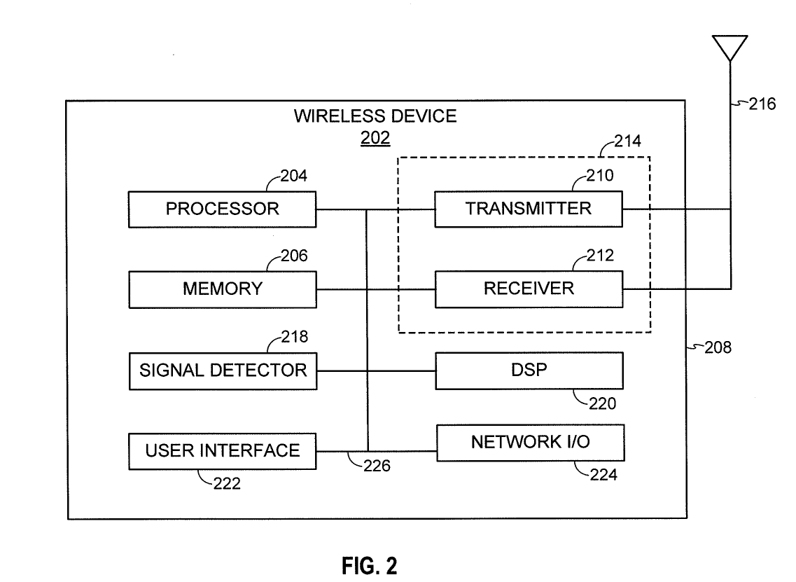

FIG. 2 illustrates an example of a functional block diagram of a wireless device that may be employed within the wireless communication network of FIG. 1. The wireless device 202 is an example of a device that may be configured to implement the various methods described herein. For example, the wireless device 202 may comprise the UE 102 of FIG. 1. The wireless device 202 may be a multimode or multiband device, capable of operating using different radio access technologies (RATS), such as but not limited to LTE, LTE Advanced, HSPA, CDMA, HRPD, eHRPD, CDMA2000, GSM, GPRS, EDGE, UMTS, or the like.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The data in memory 206 may include configuration data. Configuration data may be preloaded into the memory 206. Configuration data may be obtained from a user of the wireless device 202 (e.g., through an interface 222, SIM card, download, over the air). The processor 204 may perform logical and arithmetic operations further based on the configuration data.

In some aspects, the processor 204 is configured to cause signals to be sent and to receive signals from another device (e.g., APs 104 and/or 106). The signals may include information indicating which network service may be utilized depending at least in part on a load on one or more of the networks. The processor 204 may be further configured to enforce any access permissions to one or both of the cellular wireless network or the WLAN.

In some implementations, a network input/output (I/O) module 224 is provided. The network I/O module 224 may be configured to send and receive signals to and from network components (e.g., the APs 104 and 106). In some implementations, this may be referred to as backhaul signaling.

The processor 204 may comprise or be a component of a processing system implemented with one or more processors. The one or more processors may be implemented with any combination of microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. In some implementations, the processor 204 may be a part of or be known as “means for selectively offloading at least a subset of the data connections to the non-cellular wireless network.”

The processing system may also include a non-transitory, computer-readable medium for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that includes the transmitter 210 and/or the receiver 212 to allow transmission and reception of data between the wireless device 202 and a remote location. The transmitter 210 may be configured to wirelessly transmit status information. Further, the receiver 212 may be configured to wirelessly receive user data. The receiver 212 may be a part of or may be known as “means for receiving a first indication,” “means for receiving a second indication,” and/or “means for receiving an update of the first indication.” The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density, and other signals. The wireless device 202 may also include a digital signal processor (DSP) 220 for use in processing signals. The DSP 220 may be configured to generate a packet for transmission and/or process a received packet.

In some aspects, the wireless device 202 may further comprise a user interface 222. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements. For example, the processor 204 and the memory 206 may be embodied on a single chip. The processor 204 may additionally, or in the alternative, contain memory, such as processor registers. Similarly, one or more of the functional blocks or portions of the functionality of various blocks may be embodied on a single chip. Alternatively, the functionality of a particular block may be implemented on two or more chips.

In this specification and the appended claims, it should be clear that the terms “circuit” and “circuitry” are construed as structural terms and not as functional terms. For example, circuitry can be an aggregate of circuit components, such as a multiplicity of integrated circuit components, in the form of processing and/or memory cells, units, blocks, and the like, such as shown and described in FIG. 2. One or more of the functional blocks and/or one or more combinations of the functional blocks described with respect to the wireless device 202 may also be implemented as a combination of computing devices, e.g., a combination of a DSP and a microprocessor, a plurality of microprocessors, one or more microprocessor in conjunction with a DSP communication, or any other such configuration.

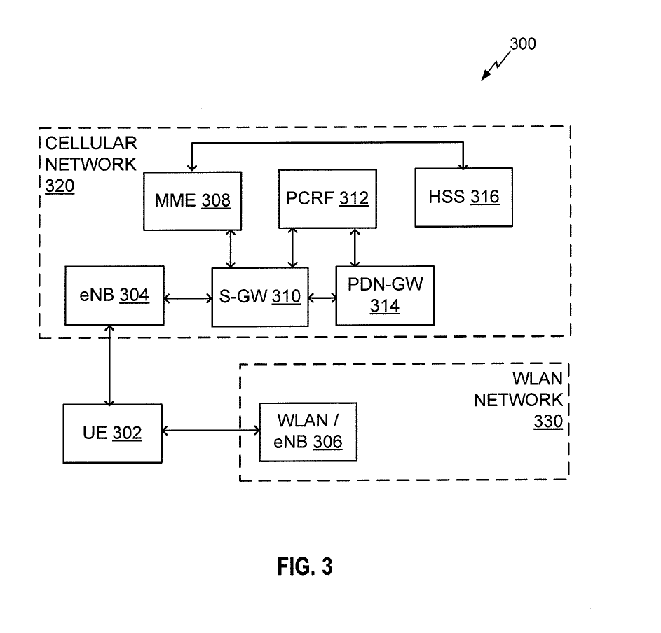

FIG. 3 illustrates an example of a functional block diagram of certain communication entities that may be employed within the wireless communication network of FIG. 1. The components shown in FIG. 3 illustrate a system in which a multimode or multiband device may communicate using multiple radio networks (RANs), for example a WLAN network and an LTE network, etc. The system 300 may include a cellular wireless network 320 that provides wireless radio communications between a UE 302 and an eNodeB 304 using, for example, LTE radio access technology. However, the cellular wireless network 320 can utilize any suitable type of radio access technology such as, but not limited to, LTE, LTE Advanced, HSPA, CDMA, HRPD, eHRPD, CDMA2000, GSM, GPRS, EDGE, UMTS, or the like. The entities shown in the cellular wireless network 320 may also be known as an evolved packet core (EPC). The system 300 may additionally include a second, non-cellular wireless network 330 that provides wireless radio communications between the UE 302 and another eNodeB 306 using, for example, WLAN or other non-cellular technology. The UE 302, eNodeB 304 and the eNodeB 306 of FIG. 3 may correspond to the UE 102, the AP 104, and the AP 106 of FIG. 1, respectively.

The core network can include a mobility management entity (MME) 308 that can be an end-point for control signaling from the cellular wireless network 320. The MME 308 can provide functions such as mobility management (e.g., tracking), authentication, and security. The core network can also include a serving gateway (S-GW) 310 which is a user plane node that connects the core network to the LTE RAN. The network 320 may also include a policy and charging rules function (PCRF) 312. The PCRF 312 may communicate with the S-GW 310, a packet data network (PDN) gateway (GW) 318 and the core network. The core network can also include the PDN-GW 314 that facilitates communications between the network 320 and external networks. The PDN-GW 314 can provide packet filtering, QoS policing, charging, IP address allocation, and routing of traffic to external networks. While illustrated as separate nodes in FIG. 3, the S-GW 310 and the PDN-GW 314, for example, can be configured to operate as a single network node to reduce user plane nodes in the core network. The network 320 may also include a home subscriber services (HSS) entity 332 which may communicate with the MME 308. In some implementations, the path between the PDN-GW 314 and the UE 302 may be referred to as a packet data network (PDN) connection. A packet data network connection may be identified by one or more network (e.g., IP) addresses.

The network 320 can communicate with external networks via the PDN-GW 314. The external networks (not shown) can include networks such as, but not limited to, a public switched telephone network (PSTN), an IP multimedia subsystem (IMS), and/or an IP network. The IP network can be the Internet, a local area network, a wide area network, an intranet, or the like. It should be appreciated that the configuration shown in FIG. 3 is an example of just one possible configuration and many other configurations and additional components may be used in accordance with various aspects and implementations described below.

To facilitate interworking between the cellular wireless network 320 and the non-cellular wireless network 330, a mechanism for providing RAN assistance parameters for offloading wireless traffic from the cellular wireless network 320 to the non-cellular wireless network 330 has been introduced. According to such a mechanism, the RAN provides the RAN assistance parameters defining the conditions under which the UE 302 should move traffic from the cellular wireless network 320 to the non-cellular wireless network 330, and vice versa, to the UE 302.

In addition, according to such a mechanism, the EPC may indicate to the UE 302 which access point names (APNs) may not be offloaded from the network 320 or alternatively which APNs may be offloaded to the non-cellular wireless network 330. Each APN may be associated with a particular data connection, as described above. Thus, at any point in time, the UE 302 may support a plurality of separate data connections with the cellular wireless network 320.

The MME 308 (or serving GPRS support node (SGSN) which is not shown) may determine which of the active data connections are to be offloaded and/or not offloaded based on pre-configured information and/or subscription data from the HSS 316. For such indications, the MME 308 or SGSN may indicate explicitly if a particular data connection is offloadable to the WLAN. A lack of such an indication for a particular data connection would implicitly indicate that the particular data connection is not offloadable. In an alternative implementation, the MME 308 or SGSN may indicate explicitly if a particular data connection is not offloadable to the WLAN. In this alternative implementation, a lack of such an indication for a particular data connection would implicitly indicate that the particular data connection is offloadable. Thus, when the UE 302 establishes a new data connection with the cellular wireless network 320, the MME 308 may indicate that this data connection is offloadable to the non-cellular wireless network 330 assuming such offload is allowed as further indicated by additional parameters such as subscription data, local configuration, or user preferences of the UE 302. Alternatively, when the UE 302 establishes a new data connection, the MME 308 may decide to not indicate that this data connection is offloadable, for example, where offloading to the non-cellular wireless network 330 is prohibited based on additional parameters such as but not limited to subscription data.

However, since such indications are transmitted (or not transmitted) at the establishment of the data connection, there is a need for dynamically adjusting the offloadability information to the UE 302 depending on factors such as but not limited to the number of currently active data connections for 3GPP access. For example, where a prior data connection was not designated as offloadable and a second data connection is established that is also not offloadable, it may be desirable to adjust the offloadability status of the prior data connection to “offloadable” since the newer data connection may now remain non-offloadable to guard against network detach. In such situations, the MME 308 may indicate to the UE 302 that the previously established data connection may now be offloaded to the non-cellular wireless network 330, assuming the additional parameters (e.g., the subscription data or local configuration of the UE 302) may allow the offload.

To provide such offloadability indications, existing network access server, or network access stratum (NAS) messages may be enhanced to include a new information element (IE) for indicating offloadability to the WLAN. For example, a “bearer context status” IE carrying the offloadability status may be included in an “accept” or “acknowledge” message sent in response to receiving a data connection activation request message. In addition, the offloadability status of an existing data connection may be subsequently modified by the MME 308 or SGSN (not shown) by providing an updated “bearer context status” in a NAS message to the UE 302 (e.g., an update of the first indication).

However, there are several considerations that must be factored into a determination as to the offloadability of particular active data connections in different types of cellular RANs. For example, for LTE networks, if the UE 302 offloads all data connections with the eNodeB 304 (e.g., all LTE traffic) to the non-cellular wireless network 330, the UE 302 will detach from the LTE cellular wireless network 320. This may be undesirable since, upon detach, the UE 302 would be required to perform a lengthy, network resource intensive attach process in order to receive further updates associated with the network or the UE 302. In the case of universal mobile telecommunications service (UMTS), even though the UE 302 is not required to detach from the UMTS, the same problem may manifest if the UE 302 moves to a GSM Edge RAN (GERAN) in idle mode. This problem may additionally apply to access network discovery and selection function (ANDSF)-based offload to the WLAN for release versions 12 and earlier. An important reason to keep an active LTE connection (e.g., at least one data connection with the cellular wireless network 320) when RAN assistance parameters are utilized is that, where only unicast radio resource control (RRC) is used to signal the RAN assistance parameters, if there are no active data connections with the network 320, the UE 302 will be unable to receive the RAN assistance parameter updates.

Thus, in order to ensure at least one data connection remains with the cellular wireless network 320 and not offloaded to the WLAN, several alternatives have been proposed. In a first alternative, the last APN routed via LTE is always declared ineligible for offload by the network and hence never offloaded. As described above, this indication may be provided via NAS signaling directly to the UE 302 (a NAS_2 solution) or by the MME 308 to the eNodeB 304 (a radio resource control (RRC) solution). This first alternative may be utilized where the UE 302 supports voice over LTE (VoLTE) as the UE 302 may maintain at least the IP multimedia subsystem (IMS) data connection over LTE. However, this alternative may not be possible if the UE 302 only maintains a single data connection. In a second alternative, assuming the UE 302 will be attached to a 2G or 3G cellular wireless network to receive circuit switched (CS) voice data, the UE 302 may read a system information block (SIB) from the legacy RAT. However, this second alternative does not work, if the UE moves to GERAN. In a third alternative, the UE 302 may read the LTE/UMTS SIB from time to time even though not camped in a LTE/UMTS cell. This third solution may be utilized for data-only UEs. However, given that different UEs may have different requirements it is proposed that the second and/or third alternatives be utilized. For utilization of the second and/or third alternatives above, a mechanism is desirable for the network to indicate whether the UE is allowed to offload the last (e.g., a single remaining) active data connection from the cellular wireless network to the WLAN.

Accordingly, in addition to the offloadability information provided as described above, the present application contemplates at least two solutions. In a first solution, the network may provide an indication (e.g., via network access stratum messages) indicating whether the UE 302 is allowed to offload the last data connection or not to the UE 302 during the attach procedure to the 3GPP network (e.g., the 2G/3G/4G/LTE cellular wireless network). In a second solution, when a data connection is created, the network may provide an indication (e.g., via NAS messages) indicating whether the UE 302 is allowed to offload the last data (e.g., PDN) connection or not to the UE 302 during the data connection request procedure. Where the first solution is utilized, the second solution may still be utilized to allow the network to modify the offloadability indication previously provided during the attach procedure. While utilizing either the first or second solution, the network may additionally update the indication to the UE 302 at any subsequent time utilizing NAS signaling (e.g. via a status update or via newly defined messages).

Thus, in either the first or second solution, the network may decide what offloadability status to indicate to the UE 302, e.g., based on a local setting of the UE 302, based on a subscription profile associated with the UE 302 indicated by the home subscriber server profile that the HSS 316 provides to the MME 308 or SGSM (not shown), or based on a subscription profile associated with the UE 302 (e.g., based on information available to the MME 308 as to whether the UE 302 is able to have access to voice/SMS services in 2G/3G and receive RAN assistance parameters in broadcast channels by reading the LTE/UMTS SIBs when not camping on the cellular cell). In short, the network may indicate to the UE 302 whether the UE 302 is allowed to offload the last or only data connection still active over the particular 3GPP access (e.g., the 2G/3G/4G/LTE network 320). The UE 302 may then decide or selectively choose, based on the indication from the network, whether to offload the last or only data connection (or which data connection will be the last or only data connection where several data connections may be offloaded) from the 3GPP access network to a non-3GPP access network (e.g., the non-cellular wireless network 330). Such offloadability information may be updated when a new data connection is established and when an active data connection is released.

Following are non-limiting examples of some types of information that may be utilized by the network 320 in determining offloadability of particular data connections. From the MME 308, visited public land mobile network (VPLMN) policies (e.g., policies for roaming users) may be utilized. The MME 308 may be configured with well-known offloadable APNs, though the MME 308 may not be aware of all offloadable APNs in roaming due to heavy configuration requirements. From the PDN-GW 314 a list of offloadable APNs may be utilized and may be provided via an additional “offload capability” information element (IE). From the HSS 316, additional IEs comprising a list of offloadable APNs per UE or per VPLMN (in the case of roaming) may be provided in an update location ACK message, for example. From the PCRF 312, additional “offload capability” IEs may carry a list of offloadable APNs per UE, per APN or per VPLMN (as stated above for the HSS 316), however, further including consideration of certain conditions (e.g., time of day, network location such as being associated with a public land mobile network (PLMN) etc.). Offloadability may additionally be per bearer and depend on quality control indicator (QCI) policies from the home operator. Such “offload capability” IEs may be included in a create session response between the S-GW 310 and the PDN-GW 314, for example. Alternatively, the “offload capability” IEs may be included in IPCAN session establishment or modification exchanges between the PDN-GW 314 and the PCRF 312. In some implementations, the offload capability may be “per bearer” and the UE 302 may be required to determine if all bearers of a particular APN may be offloaded before performing such offload.

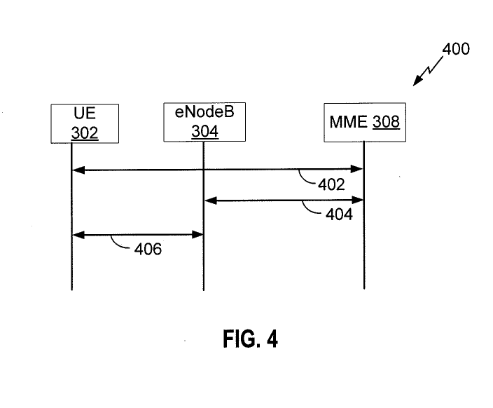

FIG. 4 illustrates a signal exchange diagram 400 for indicating offloadability of one or more data connections to non-cellular wireless networks as may be employed within the wireless communication network of FIG. 1. The signal diagram 400 illustrates several components of a communication system. The diagram includes at least the UE 302, the eNodeB 304 and the MME 308 of FIG. 3. Although one or more communications and/or transmissions may be described as occurring between two entities, the communications and/or transmission may occur via one or more intermediaries between the two entities.

Not shown is the initial signaling performed by the UE 302 to attach to the cellular (e.g., LTE) network. The UE 302 may send a communication 402 to the MME 308 indicating a data connection establishment request or PDP context request. In response, the MME 308 may transmit a communication 404 to the eNodeB 304 including a WLAN offloadability indication and also including a session management message indicating the WLAN offloadability of the just-established data connection. The eNodeB 304 may then transmit a radio resource control (RRC) message 406 including RAN assistance parameters and the session management message indicating the WLAN offloadability status of the just-established data connection.

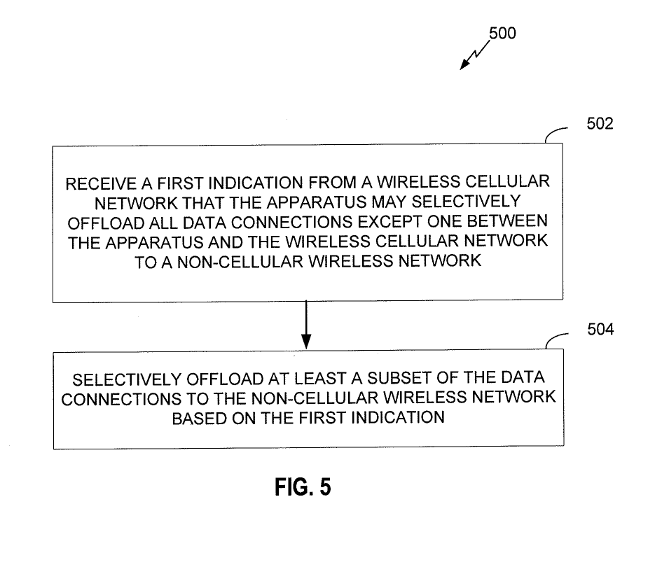

FIG. 5 shows a flowchart 500 of an example method for wireless communication that may be employed within the wireless communication network of FIG. 1. The method of flowchart 500 is described herein with reference to the previous discussion in connection with FIG. 3. In one implementation, one or more of the steps in flowchart 500 may be performed by, or in connection with, a processor, receiver and/or transmitter, such as the processor 204, the receiver 212 or the transmitter 210 of FIG. 2, although those having ordinary skill in the art will appreciate that other components may be used to implement one or more of the steps described herein. Although blocks may be described as occurring in a certain order, the blocks can be reordered, blocks can be omitted, and/or additional blocks can be added.

The method may begin with block 502, which includes receiving a first indication from a cellular wireless network that the apparatus may selectively offload all data connections except one between the apparatus and the cellular wireless network to a non-cellular wireless network. As previously described in connection with FIG. 3, the first indication may be disposed in an offloadability information element within one or more NAS messages. The first indication may be transmitted either during the attach procedure (with the cellular wireless network itself) or during a request for creating a particular data connection over the cellular wireless network after attachment to the cellular wireless network has already occurred. The cellular wireless network may be any type of cellular next work including, but not limited to, a 2G network, a 3G network, a 4G network and an LTE network. The non-cellular wireless network may comprise a WLAN WiFi network, for example.

The method may continue with block 504, which includes selectively offloading at least a subset of the data connections to the non-cellular wireless network based on the first indication. For example, although the indication of offloadability provided by the cellular wireless network indicates, in essence, whether all active data connections may be offloaded to the WLAN (e.g., a second indication) or whether one data connection must remain with the cellular wireless network (e.g., the first indication), it is the UE which makes the choice as to which if any of the data connections to offload based on the indication.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a non-transitory, computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

What is claimed is:

1. An apparatus for wireless communication, the apparatus comprising:
a receiver configured to receive a first indication from a cellular wireless network that the apparatus may selectively offload all data connections except one between the apparatus and the cellular wireless network to a non-cellular wireless network; and
a processor configured to selectively offload at least a subset of the data connections to the non-cellular wireless network based on the first indication.

2. The apparatus of claim 1, wherein the receiver is configured to receive a second indication indicating that all data connections between the apparatus and the cellular wireless network may be offloaded to the non-cellular wireless network.

3. The apparatus of claim 1, wherein the receiver is configured to receive the first indication during an attach procedure between the apparatus and the cellular wireless network.

4. The apparatus of claim 1, wherein the receiver is configured to receive the first indication during a data connection request procedure with the cellular wireless network.

5. The apparatus of claim 1, wherein the receiver receives the first indication in one or more network access stratum messages.

6. The apparatus of claim 1, wherein the receiver is further configured to receive an update of the first indication in one or more network access stratum messages.

7. The apparatus of claim 1, wherein the first indication is based on at least one of a local setting of the apparatus, a communication capability of the apparatus, and a subscription profile associated with the apparatus.

8. A method for wireless communication, the method comprising:
receiving a first indication from a cellular wireless network that an apparatus may selectively offload all data connections except one between the apparatus and the cellular wireless network to a non-cellular wireless network; and
selectively offloading at least a subset of the data connections to the non-cellular wireless network based on the first indication.

9. The method of claim 8, comprising receiving a second indication indicating that all data connections between the apparatus and the cellular wireless network may be offloaded to the non-cellular wireless network.

10. The method of claim 8, comprising receiving the first indication during an attach procedure between the apparatus and the cellular wireless network.

11. The method of claim 8, comprising receiving the first indication during a data connection request procedure between the apparatus and the cellular wireless network.

12. The method of claim 8, wherein the first indication is received in one or more network access stratum messages.

13. The method of claim 8, comprising receiving an update of the first indication in one or more network access stratum messages.

14. The method of claim 8, wherein the first indication is based on at least one of a local setting of the apparatus, a communication capability of the apparatus, and a subscription profile associated with the apparatus.

15. An apparatus for wireless communication, the apparatus comprising:
means for receiving a first indication from a cellular wireless network that the apparatus may selectively offload all data connections except one between the apparatus and the cellular wireless network to a non-cellular wireless network; and
means for selectively offloading at least a subset of the data connections to the non-cellular wireless network based on the first indication.

16. The apparatus of claim 1, comprising means for receiving a second indication indicating that all data connections between the apparatus and the cellular wireless network may be offloaded to the non-cellular wireless network.

17. The apparatus of claim 1, wherein the means for receiving is configured to receive the first indication during an attach procedure between the apparatus and the cellular wireless network.

18. The apparatus of claim 1, wherein the means for receiving is configured to receive the first indication during a data connection request procedure with the cellular wireless network.

19. The apparatus of claim 1, wherein the means for receiving receives the first indication in one or more network access stratum messages.

20. The apparatus of claim 1, further comprising means for receiving an update of the first indication in one or more network access stratum messages.

21. The apparatus of claim 1, wherein the indication is based on at least one of a local setting of the apparatus, a communication capability of the apparatus, and a subscription profile associated with the apparatus.

22. A non-transitory computer-readable medium comprising code that, when executed causes an apparatus for wireless communication to:
receive a first indication from a cellular wireless network that the apparatus may selectively offload all data connections except one between the apparatus and the cellular wireless network to a non-cellular wireless network; and
selectively offload at least a subset of the data connections to the non-cellular wireless network based on the first indication.

23. The non-transitory computer-readable medium of claim 22, wherein the code, when executed, causes the apparatus to receive a second indication indicating that all data connections between the apparatus and the cellular wireless network may be offloaded to the non-cellular wireless network.

24. The non-transitory computer-readable medium of claim 22, wherein the first indication is received during an attach procedure between the apparatus and the cellular wireless network.

25. The non-transitory computer-readable medium of claim 22, wherein the first indication is received during a data connection request procedure between the apparatus and the cellular wireless network.

26. The non-transitory computer-readable medium of claim 22, wherein the first indication is received in one or more network access stratum messages.

27. The non-transitory computer-readable medium of claim 22, wherein the code, when executed, causes the apparatus to receive an update of the first indication in one or more network access stratum messages.

28. The non-transitory computer-readable medium of claim 22, wherein the first indication is based on at least one of a local setting of the apparatus, a communication capability of the apparatus, and a subscription profile associated with the apparatus.
